(19) United States
(12) Patent Application Publication
(10) Pub. No.: US 2025/0158540 A1
(43) Pub. Date: May 15, 2025

(54) DEVICE AND METHOD FOR SUPPLYING POWER TO A DC LOAD

(71) Applicant: Siemens Energy Global GmbH & Co. KG, München (DE)

(72) Inventors: Julian Lange, Regensburg (DE); Rolf Neubert, Fürth (Bay.) (DE); Thomas Vielberth, Nürnberg (DE); Daniel Schmitt, Postbauer-Heng (DE)

(21) Appl. No.: 18/833,423

(22) PCT Filed: Dec. 20, 2022
(86) PCT No.: PCT/EP2022/086880

§ 371 Date: Jul. 26, 2024

(30) Foreign Application Priority Data
Jan. 31, 2022 (EP) 22154132.9

(51) Int. Cl. H02M 7/515; C25B 9/65

(52) U.S. Cl. CPC H02M 7/515; C25B 9/65

(57) ABSTRACT

The invention relates to a device for supplying a DC load with a transformer arrangement and a converter. The invention is characterized in that the transformer arrangement is connected on the mains side by the converter to a supply network and on the load side to the DC load to be supplied. A direct current is generated on the load side by regulation of the converter. The invention further relates to a method for supplying a DC load by the device according to the invention.

### BACKGROUND

The invention relates to a device for supplying power to a DC load using a transformer arrangement and a converter.

A DC load within this context is a load that is supplied with electric power by means of a DC current. A DC load may be for example a PEM electrolyzer (Proton Exchange Membrane electrolyzer) or an electric arc furnace. As high an input-side DC current as possible is usually advantageous for supplying power to such DC loads.

In particular for water electrolysis by means of a PEM electrolyzer, the electric current from the grid connection needs to be rectified and automatically controlled so that the desired electrochemical process can take place in the electrolyzer and the power to be converted can be matched to the grid requirements. The generally constantly rising need for hydrogen calls for a particularly high level of hydrogen production in future, that is to say also particularly high supply currents. One challenge for this, inter alia, is that of providing a very high supply current given very low voltage on the electrolyzer. In general, there are supply devices for electrolysis plants comprising a transformer and a controllable power-electronics converter. The latter is needed in order to rectify the grid current and to ensure that the power to be converted is automatically controllable. The controllable power electronics have hitherto been installed on the secondary side of the transformer. The high currents result in very high losses in the semiconductors (P˜I\hat{ }2) on the secondary side. Furthermore, the control dynamics of the converter are limited.

A known device of the type cited at the outset is shown in FIG. 1. The device 1 comprises a transformer 2 and a converter, or rectifier, 3. In the example shown in FIG. 1, the converter is a thyristor bridge. The transformer 2 is connected on the grid side directly to a supply grid 4 and on the load side, by means of the converter 3, to a DC load, in the example shown an electrolysis plant having an electrolyzer stack 5. The topology of the power electronics of the converter 3 results from the demands on the electrical parameters and the quality of the rectification. Parameter specifications are in particular a stack voltage Ustack and a stack current Istack, which are produced from a grid voltage Ugrid and a grid current Igrid. Using the thyristor bridge has the advantage of relatively low losses and the disadvantage of a residual ripple in the output voltage (stack voltage). The electrolysis plant normally comprises a gas dryer 6, a gas compressor 7 and/or a pressure store 8, which are connected downstream of the PEM stack 5.

### SUMMARY

The object of the invention is to specify a device of the type in question that is as efficient and reliable as possible, in particular with regard to high output currents.

The invention achieves the object for the device of the type in question in that the transformer arrangement is connectable on the grid side to a (polyphase) supply grid, suitably having at least three phases, by means of the converter and on the load side to the DC load that is to be supplied with power, and the converter is configured, suitably by means of a feedback control apparatus configured for this purpose, to produce a load-side DC current. Accordingly, during operation of the device, the transformer arrangement is connected on the secondary side (load side) to the DC load and on the primary side to the converter, which is in turn connected to the supply grid. In contrast to known devices of this type, the converter in the device according to the invention is arranged on the primary side (grid side) of the transformer arrangement. Suitable automatic control can be used to operate the converter in such a way that a DC current (supply current) is produced on the output side of the device in order to supply power to the DC load.

The device according to the invention has the advantage that the converter needs to be designed not for the particularly high output currents (load-side currents) but rather for the grid-side currents. Advantageously, suitable dimensioning of the transformers, in particular the winding ratio thereof, and the topology of the converter permit extensive scalability of the device. Furthermore, the connection-side flexibility of the proposed topology also permits integration into a DC grid, for example within a solar farm. If the converter is, by way of example, a modular multilevel converter comprising, in each phase, a series connection of switching modules that each comprise disconnectable semiconductor switches and a dedicated switching-module energy store, further advantages arise. The (control-) dynamic properties of the multilevel converter allow the secondary current to be automatically controlled with high accuracy and almost without residual ripple. Moreover, the short reaction time in the range of a few tens of microseconds allows a secondary-side fault current to be reliably disconnected following detection. This makes it possible to dispense with high-current disconnection devices on the secondary side (load side).

In one embodiment, the converter comprises a first converter branch and a second converter branch, wherein the transformer arrangement comprises a first and a second transformer, wherein the first transformer and the second transformer are connectable (or, during operation, connected) to the supply grid by means of the first converter branch and the second converter branch, respectively, and wherein load-side windings of the first and second transformers are connected in series or parallel with one another. Connecting the windings in parallel on the output side permits particularly high output currents, or also output currents that are phase-shifted with respect to one another. Each of the converter branches expediently contains a converter valve comprising controllable power semiconductors. In a three-phase application, three converter branches may be connected to one another and to the supply grid in a delta connection.

According to one embodiment of the invention, the first converter branch is switchable between a first and a second phase of the supply grid (or extends between these phases during operation of the device) and comprises a first grid-side converter arm and a first transformer-side converter arm, the first transformer being connected in parallel with the first transformer-side converter arm. The second converter branch is switchable between a second and a third phase of the supply grid (or extends between these phases during operation of the device) and comprises a second grid-side converter arm and a second transformer-side converter arm, the second transformer being connected in parallel with the second transformer-side converter arm. The converter branches are accordingly each divided into two converter arms, the associated transformer being connected in parallel with the respective transformer-side converter arm on the converter side (or on the grid side or primary side). The respective transformer-side converter arm is suitably configured to automatically control the transformer-side current.

Expediently, the first and second grid-side and transformer-side converter arms each comprise a series connection of switching modules, each switching module comprising (suitably disconnectable) power semiconductor switches, for example IGBTs, IGCTs or the like) and a dedicated switching-module energy store (e.g. a capacitor). The power semiconductors and the energy store are expediently connected to one another in a full-bridge circuit. With this design, the converter is a modular multilevel converter. The modular converter topology, which generally allows free selection of the number of switching modules in each converter arm, and the choice of transformer advantageously allows scalability for different voltage and power classes. The voltages of the individual energy stores are preferably balanced (so that the energy stores are evenly loaded) by means of a suitable balancing algorithm.

In one embodiment, a feedback control apparatus can be used to produce a first converter voltage on the first transformer-side converter arm and a second converter voltage on the first grid-side converter arm, a sum of the first and second converter voltages corresponding to a grid voltage of the supply grid. Accordingly, the respective transformer-side converter arm can be used to set transformer-side voltage needed for automatically controlling the transformer-side current, while the respectively assigned grid-side converter arm is used to set, or produce, a compensating voltage so that the transformer-side voltage is compensated for with respect to the grid voltage of the supply grid.

According to one embodiment of the invention, to avoid circulating currents in the device there is provision on the load side of the transformer arrangement for at least one power semiconductor having a reverse direction and a forward direction. The arrangement of the power semiconductors on the output side of the device allows mutual influencing of the transformers to be avoided. Alternatively, the power semiconductors may also be arranged on the primary side (grid side) of the device. The at least one power semiconductor is expediently arranged in series with the load-side winding of the (respective) transformer.

In one embodiment, the at least one power semiconductor is a diode or a thyristor. Diodes and thyristors are semiconductors that are particularly robust with respect to high currents.

Use of the device in an arrangement for producing hydrogen is considered to be particularly advantageous. A corresponding arrangement comprises an electrolysis plant, the input side of which is connected by means of a supply device for supplying electric power to the electrolysis plant, the supply device being a device according to the invention.

The invention also relates to a method for supplying power to a DC load by means of a device comprising a transformer arrangement and a converter.

The object of the invention is to specify a method that allows the DC load to be supplied with electric power as effectively and reliably as possible.

The invention achieves the object for a method of the type in question in that the transformer arrangement is connected on the grid side to a supply grid by means of the converter and on the load side to the DC load that is to be supplied with power, and automatic control of the converter is used to produce a DC current (which can also be referred to as the supply current) on the load side.

The advantages of the method according to the invention result in particular from the advantages described in connection with the device according to the invention.

In one embodiment, the transformer arrangement comprises a first, a second and a third transformer, which are each connected on the grid side to the converter and connectable on the load side to the DC load, the converter being used to produce a first trapezoidal output current response (the time characteristic of a first load-side output current on the first transformer) on the load side of the first transformer, a second trapezoidal output current response (the time characteristic of a second load-side output current on the second transformer) on the load side of the second transformer and a third trapezoidal output current response (the time characteristic of a third load-side output current of the third transformer) on the load side of the third transformer, the three output currents being phase-shifted with respect to one another to produce the load-side DC current. A trapezoidal output current response is understood to mean a current response that has a rising edge followed by a substantially constant response and then a falling edge. Suitably, the output current response is nonnegative (or nonpositive, depending on the convention). To produce the output-side DC current, the three phases are connected up to one another, and driven with a phase shift, such that the output-side (secondary-side) current trapeziums are superposed to form a substantially (within the bounds of technical implementability) constant DC current. It should be noted in this context that this method is not limited to three-phase grids and accordingly can also be applied to a different number of phases (>1) in principle.

### BRIEF DESCRIPTION OF THE DRAWINGS

The invention will be explained further hereinbelow on the basis of examples depicted in FIGS. 2 to 5.

FIG. 2 shows a first exemplary embodiment of the device according to the invention in a schematic representation;

FIG. 3 shows a second exemplary embodiment of the device according to the invention in a schematic representation;

FIG. 4 shows a converter arm for one of the devices of FIGS. 2 and 3 in a schematic representation;

FIG. 5 shows a response of current and voltage in a method according to the invention.

### DETAILED DESCRIPTION

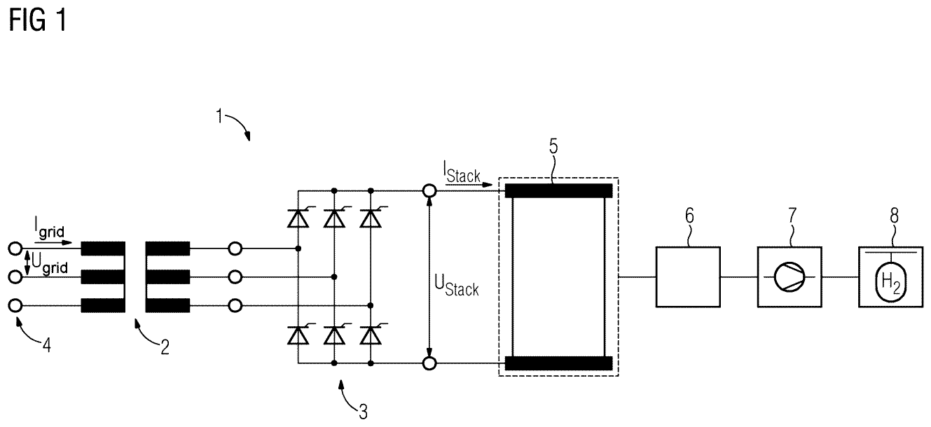

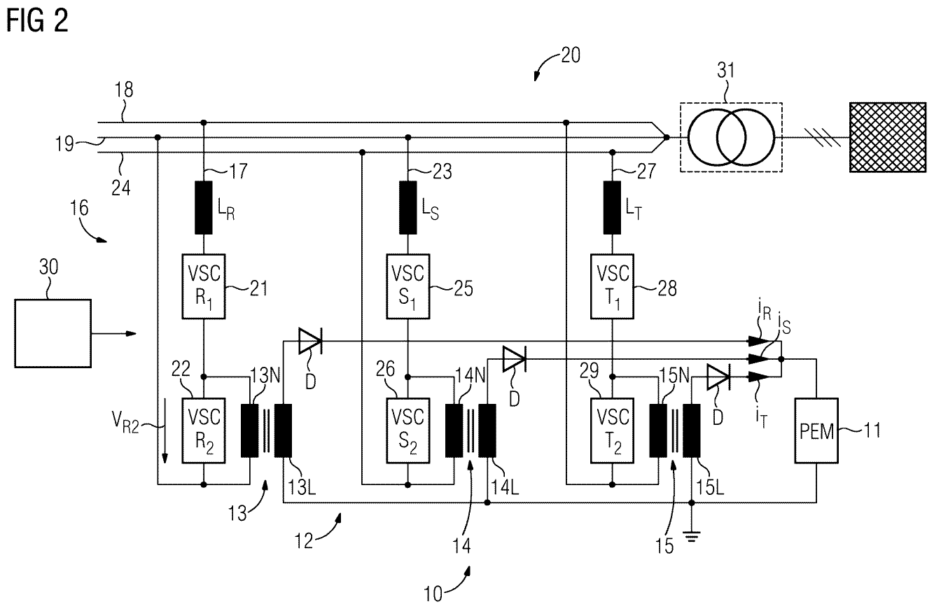

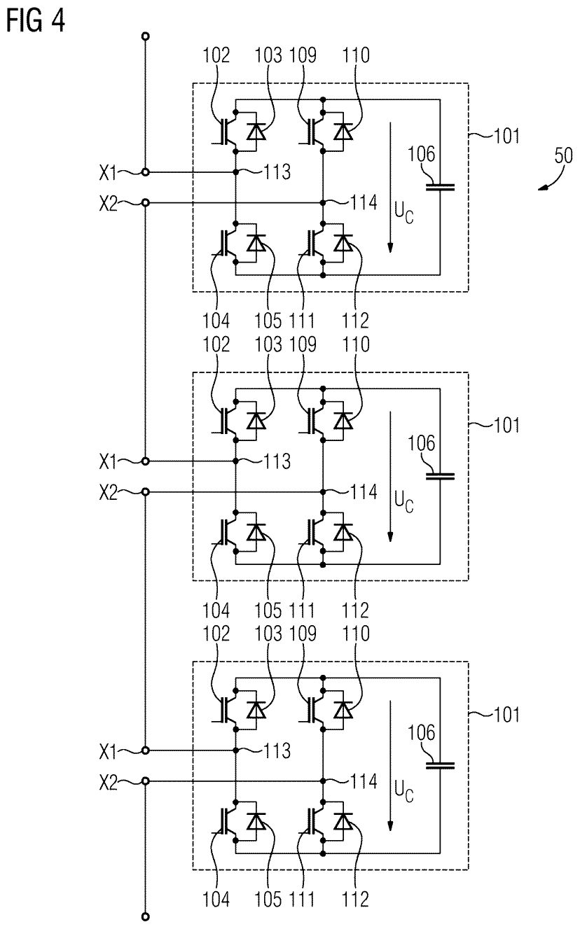

FIG. 2 depicts a device 10 for supplying power to a DC load. The DC load in the example depicted in FIG. 2 is an electrolysis plant 11. The device 10 comprises a transformer arrangement 12 having a first transformer 13, a second transformer 14 and a third transformer 15. The device 10 also comprises a converter 16. The converter 16 comprises a first converter branch 17 that extends between a first and a second phase 18 and 19, respectively, of a supply grid 20. The first converter branch comprises a first inductor LR, a first grid-side converter arm 21 and a second transformer-side converter arm 22. The design of the converter arms is discussed in more detail in FIG. 4 hereinbelow. The converter 16 also comprises a second converter branch 23 that extends between the second and a third phase 19 and 24, respectively, of the supply grid 20. The second converter branch 23 comprises a second inductor LS, a second grid-side converter arm 25 and a second transformer-side converter arm 26. The converter 16 moreover comprises a third converter branch 27 that extends between the first and the third phase 18 and 24, respectively, of the supply grid 20. The third converter branch 27 comprises a third inductor LT, a third grid-side converter arm 28 and a third transformer-side converter arm 29. It can be seen that the transformer arrangement 12 is connectable on the grid side to a supply grid 20 by means of the converter 16 and on the load side to the DC load 11 that is to be supplied with power. The converter 16 also comprises a feedback control apparatus 30 that is configured to control, or automatically control, the converter arms 21, 22, 25, 26, 28 and 29. The feedback control apparatus 30 can be used to produce a transformer-side voltage on the respective transformer-side converter arm, said voltage being denoted by VR2 for the first transformer-side converter arm 22. It can moreover be seen that the device 10 can optionally be connected to a supply grid by means of another transformer 31.

The first transformer 13 has a first grid-side winding 13N, which is arranged so as to be connected in parallel with the first transformer-side converter arm 22, and a first load-side winding 13L, which is arranged so as to be connected in parallel with the DC load 11. The second transformer 14 has a second grid-side winding 14N, which is arranged so as to be connected in parallel with the second transformer-side converter arm 26, and a second load-side winding 14L, which is arranged so as to be connected in parallel with the DC load 11. The third transformer 15 has a third grid-side winding 15N, which is arranged so as to be connected in parallel with the third transformer-side converter arm 29, and a third load-side winding 15L, which is arranged so as to be connected in parallel with the DC load 11. The load-side windings 13L, 14L, 15L are arranged in parallel with one another on the secondary side, or load side. Moreover, there is provision for unidirectional power semiconductors D in parallel with the respective load-side windings 13L, 14L, 15L. The output-side, or load-side, currents are each denoted by iR, iS and iT.

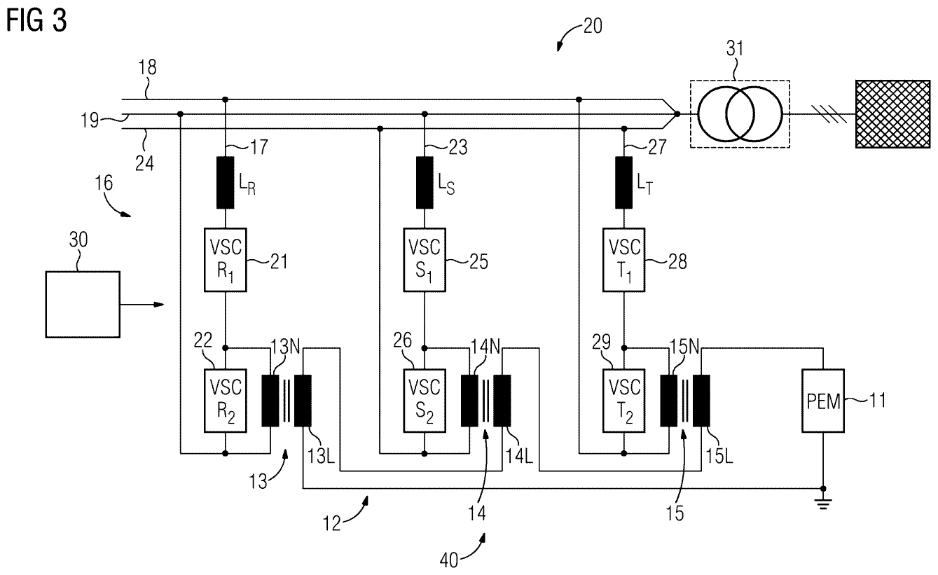

FIG. 3 depicts a device 40 for supplying power to a DC load 11. Identical and similar elements and components have been provided with identical reference signs in FIGS. 2 and 3. In contrast to the device 10 of FIG. 2, the load-side windings 13L, 14L and 15L are connected to one another in a series connection, this series connection being arranged in parallel with the DC load 11. Moreover, the unidirectional power semiconductors (the diodes D in FIG. 2) have been dispensed with.

FIG. 4 shows the possible design of a converter arm 50 that can be used as one of the converter arms 21, 22, 25, 26, 28, 29 of FIGS. 2 and 3. The converter arm 50 has a series connection of switching modules 101 (so-called full-bridge switching modules). In the example depicted here, the converter arm 50 comprises three switching modules, but in general the number thereof is arbitrary and matchable to the particular application.

The switching module 101 has a first semiconductor switch 102 in the form of an IGBT, with which a freewheeling diode 103 is connected in antiparallel, and a second semiconductor switch 104 in the form of an IGBT, with which a freewheeling diode 105 is connected in antiparallel. The forward direction of the two semiconductor switches 102 and 104 is rectified. Furthermore, the switching module 101 has a third semiconductor switch 109 in the form of an IGBT, with which a freewheeling diode 110 is connected in antiparallel, and a fourth semiconductor switch 111 in the form of an IGBT, with which a freewheeling diode 112 is connected in antiparallel. The forward direction of the two semiconductor switches 109 and 111 is rectified. The semiconductor switches 102 and 104 with associated freewheeling diodes 103, 105 thus form a series connection that is connected in parallel with a series connection formed by the semiconductor switches 109, 111 and the associated freewheeling diodes 110 and 112. A DC-link capacitor 106 is arranged in parallel with the two series connections. The first terminal X1 is arranged at a potential point 113 between the semiconductor switches 102, 104, and the second terminal X2 is arranged at a potential point 114 between the semiconductor switches 109, 111. Suitable control of the power semiconductors 102, 104, 109 and 111 can be used to produce the voltage dropped across the terminals X1, X2, which corresponds to the voltage Uc dropped across the DC-link capacitor 106, but to the voltage dropped across the DC-link capacitor 106 with the opposite polarity (−Uc) or the voltage zero.

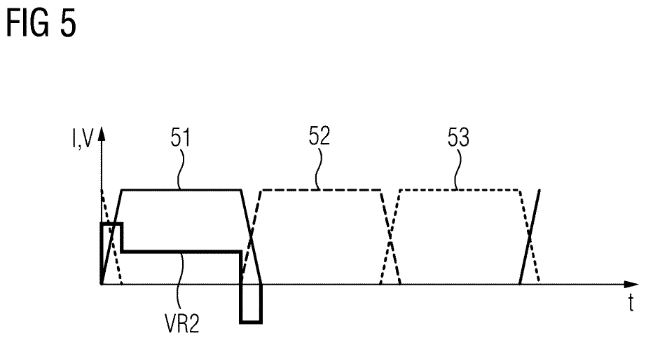

FIG. 5 uses a graph to depict the current and voltage responses that are produced by means of the converter of the device 10 or 50 for supplying power to the DC load 11. To preserve clarity, FIG. 5 depicts only the voltage VR2 that is set by means of the first transformer-side converter arm 22 (cf. FIGS. 2 and 3). The resultant output current response 51 of a first output-side current iR (cf. FIG. 2) is trapezoidal, as can be seen. The accordingly produced output current responses 52 and 53 of the load-side currents iS and iT (cf. FIG. 2) are likewise trapezoidal, but each phase-shifted with respect to one another in such a way that a load-side total DC current iGES=iR+iS+iT is obtained.

1. A device for supplying power to a DC load using a transformer arrangement and a converter,
characterized in that the transformer arrangement is connectable on the grid side to a supply grid by means of the converter and on the load side to the DC load that is to be supplied with power, and the converter is configured to produce a load-side DC current.

2. The device as claimed in claim 1, wherein the converter comprises a first converter branch and a second converter branch and the transformer arrangement comprises a first and a second transformer, wherein the first transformer and the second transformer are connectable to the supply grid by means of the first converter branch and the second converter branch, respectively, and wherein load-side windings of the first and second transformers are connected in series or parallel with one another.

3. The device as claimed in claim 2, wherein
the first converter branch is switchable between a first and a second phase of the supply grid and comprises a first grid-side converter arm and a first transformer-side converter arm, the first transformer being connected in parallel with the first transformer-side converter arm, and
the second converter branch is switchable between a second and a third phase of the supply grid and comprises a second grid-side converter arm and a second transformer-side converter arm, the second transformer being connected in parallel with the second transformer-side converter arm.

4. The device as claimed in claim 3, wherein the first and second grid-side and transformer-side converter arms each comprise a series connection of switching modules, each switching module comprising power semiconductor switches and a dedicated switching-module energy store.

5. The device as claimed in claim 3, wherein a feedback control apparatus can be used to produce a first converter voltage on the first transformer-side converter arm and a second converter voltage on the first grid-side converter arm, a sum of the first and second converter voltages corresponding to a grid voltage of the supply grid.

6. The device as claimed in claim 3, wherein to avoid circulating currents in the device the load side of the transformer arrangement has provision for a power semiconductor (D) having a reverse direction and a forward direction.

7. The device as claimed in claim 6, wherein the power semiconductor (D) is a diode or a thyristor.

8. An arrangement for producing hydrogen, comprising an electrolysis plant that is connected on the input side by means of a supply device for supplying electric power to the electrolysis plant,
characterized in that
the supply device is a device as claimed in claim 1.

9. A method for supplying power to a DC load by means of a device comprising a transformer arrangement and a converter, the transformer arrangement being connected on the grid side to a supply grid by means of the converter and on the load side to the DC load that is to be supplied with power, in which automatic control of the converter is used to produce a DC current on the load side.

10. The method as claimed in claim 9, wherein the transformer arrangement comprises a first, a second and a third transformer, which are each connected on the grid side to the converter and on the load side to the DC load, the converter being used to produce a first trapezoidal output current response on the load side of the first transformer, a second trapezoidal output current response on the load side of the second transformer and a third trapezoidal output current response on the load side of the third transformer, the three output currents being phase-shifted with respect to one another to produce the load-side DC current.
